(19) United States
(12) Patent Application Publication
(10) Pub. No.: US 2012/0072362 A1
(43) Pub. Date: Mar. 22, 2012

(54) AIR WAYBILL SECURITY CHECKS

(76) Inventors: William Loebertmann, Shakopee, MN (US); JoAnn Jancik, Victoria, MN (US)

(21) Appl. No.: 12/886,992

(22) Filed: Sep. 21, 2010

(51) Int. Cl. G06Q 10/00

(52) U.S. Cl. 705/331; 705/337

(57) ABSTRACT

Security checks may be implemented in computer systems or software to enforce security rules established by organizations and/or government entities. For example, the United States Transportation Security Administration and Canada Transport have recently established rules for air cargo transportation. When an air waybill is created, modified, and/or displayed a security check may be run on the air waybill. Rules for the air waybill may be selected according to a security code assigned to the air waybill. The security code may represent a country whose rules should be applied against the air waybill when performing the security check. If a security check is passed security information such as a security identifier may be displayed on the air waybill. If the security check fails a warning may be displayed to a user indicating which participant on the air waybill failed one of the security rules.

### TECHNICAL FIELD

The present invention relates to a computer system. More specifically, the present invention relates to a security system for monitoring shipments.

### BACKGROUND OF THE INVENTION

Recently, new security checks have been implemented by certain organizations and/or governments for air cargo transportation. For example, the United States Transportation Security Administration and Canada Transport have added security checks for air cargo transportation. Conventional systems and software for creating and storing air waybills do not assist in the enforcement of security rules implemented by these organizations and/or countries for checking security on air cargo. Thus, there is a need for implementing a security check for air waybills according to one or more rule sets for the countries involved in air cargo transportation.

### BRIEF SUMMARY OF THE INVENTION

According to one embodiment, a method includes determining, in a processor, if a shipment is subject to a security check. The method also includes applying, in the processor, at least one security rule to information regarding the shipment. The method further includes if at least one security rule fails during application to the information regarding the shipment generating, in the processor, a security message.

According to another embodiment, a computer program product includes a computer-readable medium having code to determine if a shipment is subject to a security check. The medium also includes code to apply at least one security rule to information regarding the shipment. The medium further includes code to generate a security message if at least one security rule fails during application to the information regarding the shipment.

According to yet another embodiment, an apparatus includes a processor and a memory coupled to the processor. The processor is configured to determine if a shipment is subject to a security check. The processor is further configured to apply at least one security rule to information regarding the shipment. The processor is also configured to generate a security message if at least one security rule fails during application to the information regarding the shipment.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the technology of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present invention, reference is now made to the following descriptions taken in conjunction with the accompanying drawings.

FIG. 1 is a schematic block diagram illustrating one embodiment of an exemplary system for performing security checks according to one embodiment.

FIG. 2 is a schematic block diagram illustrating one embodiment of an exemplary database system for storing air waybills and security rules.

FIG. 3 is a schematic block diagram illustrating one embodiment of an exemplary computer system that may be used in accordance with certain embodiments of the system for performing security checks.

FIG. 4 is a flow chart illustrating a method for enforcing security requirements according to one embodiment.

FIG. 5 is a flow chart illustrating a method for applying United States security rules according to one embodiment.

FIG. 6 is a flow chart illustrating a method for applying Canadian security rules according to one embodiment.

FIG. 7 is a form illustrating participant information and status messages according to one embodiment.

FIGS. 8A-B are block diagrams illustrating status messages for an air waybill according to one embodiment.

### DETAILED DESCRIPTION OF THE INVENTION

Exemplary systems and software may implement security checks for air waybills to enforce security rules imposed on air cargo transportation by organizations and/or government entities. For example, security rules set by the United States Transportation Security Administration and Canada Transport may be stored in a data storage device and applied to air waybills by a processor. The processor may compare the security rules against an air waybill each time the air waybill is created, modified, and/or displayed. The results of the security check may be displayed to a user through a display adapter and a display.

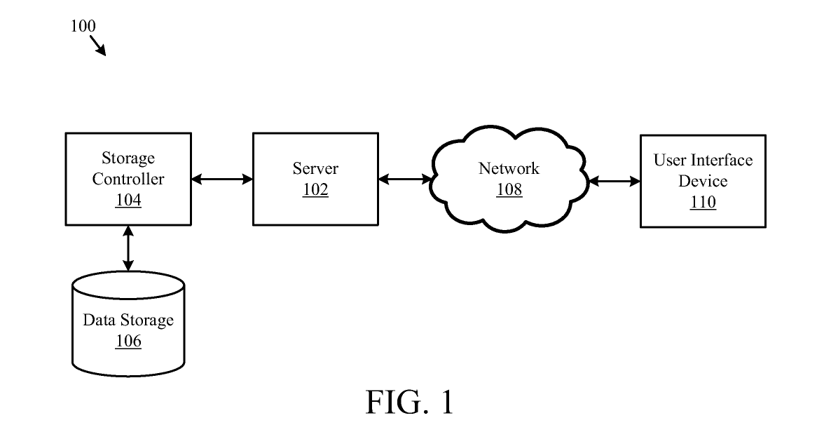

FIG. 1 illustrates one embodiment of a system 100 for enforcing security requirements. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter information regarding shipper statuses into the system 100.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to enforce security requirements for one or more government agencies. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store shipper security statuses. The data may be arranged in a database and accessible through Structured Query Language (SQL) queries, or other data base query languages or operations.

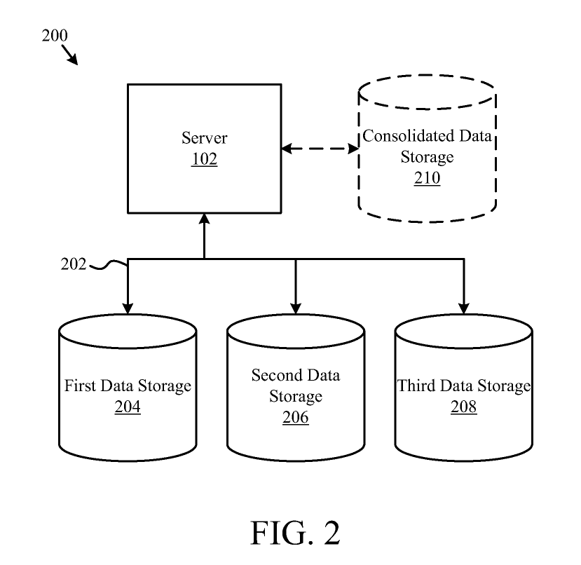

FIG. 2 illustrates one embodiment of a data management system 200 configured to store air waybills and/or security rules. For example, the data management system 200 may store participant information. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data storage devices 204, 206 to check a participant's security status. The server 102 may store the consolidated data set in a consolidated data storage device 210. In such an embodiment, the server 102 may refer back to the consolidated data storage device 210 to obtain a set of data elements associated with a specified participant. Alternatively, the server 102 may query each of the data storage devices 204, 206, 208 independently or in a distributed query to obtain the set of data elements associated with a participant. In another alternative embodiment, multiple databases may be stored on a single consolidated data storage device 210.

The data management system 200 may also include files for enforcing security requirements. In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may host a software application configured for enforcing security requirements. The software application may further include modules and/or code stored on a computer-readable medium for interfacing with the data storage devices 204, 206, 208, 210, interfacing a network 108, interfacing with a user through the user interface device 110, and the like. In a further embodiment, the server 102 may host an engine, application plug-in, or application programming interface (API).

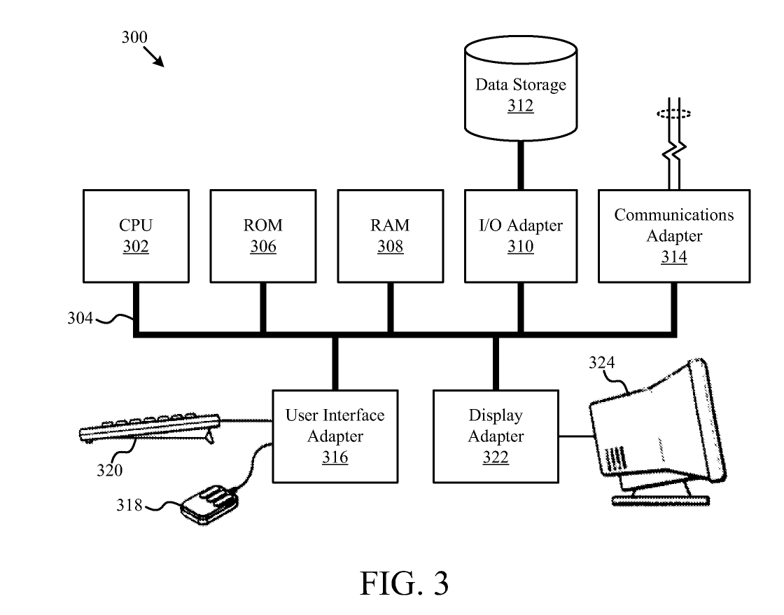

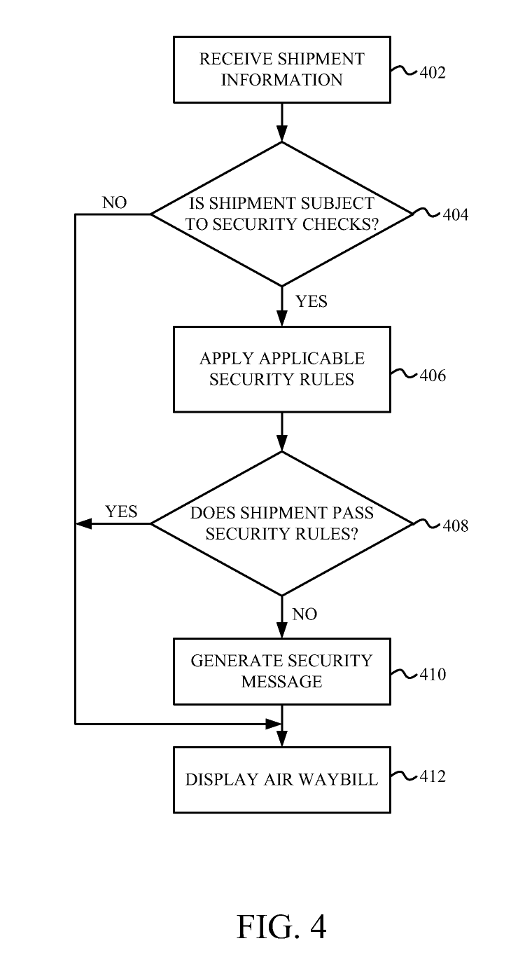

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions, such as the methods of FIGS. 4, 5, and 6, according to the present embodiments.

The computer system 300 also may include random access memory (RAM) 308, which may be SRAM, DRAM, SDRAM, or the like. The computer system 300 may utilize RAM 308 to store the various data structures used by a software application configured to identifying system redundancy and consolidation opportunities. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input information for an air waybill. In a further embodiment, the display adapter 322 may display a graphical user interface associated with a software or web-based application for enforcing security requirements.

The I/O adapter 310 may connect one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

FIG. 4 is a flow chart illustrating a method for enforcing security requirements according to one embodiment. At block 402 shipment information is received and at block 404 it is determined if the shipment is subject to security checks. Shipment information may be received, for example, any time an air waybill is created, modified, and/or displayed. If the shipment is subject to security checks any applicable security rules are applied at block 406. Security checks for a shipment may be based on, for example, the origin of the shipment, the destination of the shipment, contents of the shipment, and/or a participant in the shipment. According to one embodiment, rules applied to a shipment may be based, in part, on a two-character security code assigned to the shipment. The security code may correspond to a country involved in the shipment. At block 408 if the shipment passes the applicable security rules applied at block 406 the method continues to block 412 to display the air waybill. At block 408 if the shipment does not pass the applicable security rules applied at block 406 the method continues to block 410 to generate a security warning on the air waybill and to block 412 to display the air waybill. If the shipment is not subject to security checks the air waybill is displayed at block 412.

According to one embodiment, exemptions to the security rules applied at block 406 may be configured for an air waybill or a participant on the air waybill. For example, exceptions to security checks may be made for shipper loaded ULD, shrink-wrapped skids or pallets, banded skids or pallets, dangerous goods, sealed federal reserve or U.S. Treasury shipments, human organs and by-products, diagnostic specimens (e.g., biological substances), human blood and by-products, human remains, emergency life-saving drugs, special exemption procedures, mail, interline from other transportation security administration (TSA)-approved carriers, aircraft on ground (AOG) of non-U.S. origin, foreign trade regulations (FRTR)—hard sided locked ULD, Department of Defense shipments, FRTR—COMAT or AOG, FRTR—cannot open from inside, FRTR—no opening for individual, FRTR—no access to flight deck, and/or FRTR—piece <150 pounds. The exemptions may be configured and customized for individual airlines and/or security codes (e.g., different countries).

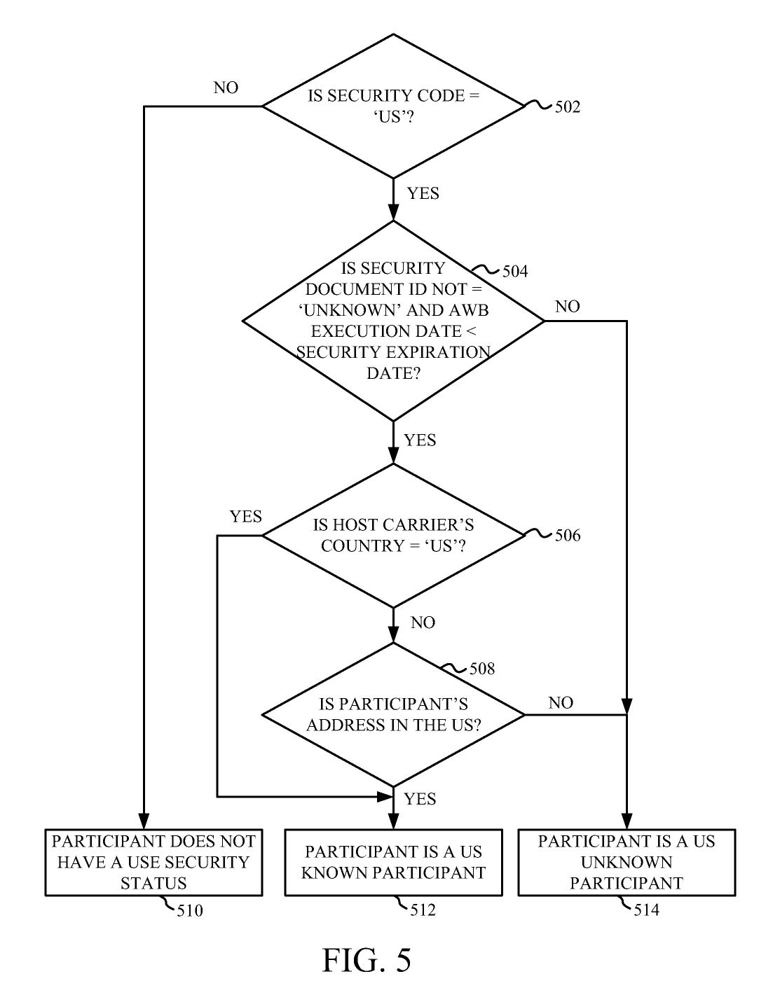

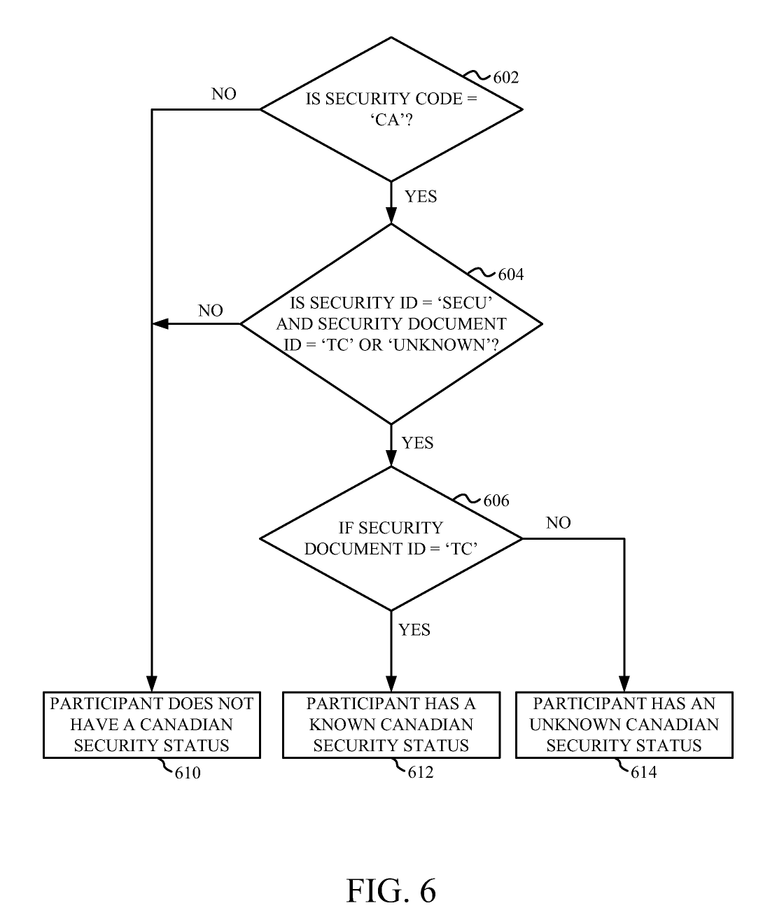

The security rules applied to a shipment at block 406 may depend on information about the shipment. For example, a security code for shipment may specify a certain country's security rules. Referring to FIGS. 5 and 6 security rules applied to a shipment in the United States and Canada, respectively, are described according to one embodiment.

FIG. 5 is a flow chart illustrating a method for applying United States security rules according to one embodiment. At block 502 a shipment is checked for a security code indicating a United States security code. If the shipment is not designated with a ‘US’ security code the participant is marked as having no U.S. security status at block 510. If the shipment is designated with a ‘US’ security code at block 504 the security document ID is checked for an unknown status and the air waybill (AWB) execution date is compared to the security expiration date. If the security document id is unknown or the execution date is later than the security expiration date the participant is marked as an unknown participant in the U.S. at block 514. If the security document id is not unknown and the execution date is prior to the security expiration date the host carrier's country is checked at block 506. If the host country equals ‘US’ then the participant is marked as a U.S. known participant at block 512. If the host carrier's country is not ‘US’ the participant's address is checked at block 508. If the participant's address is in the U.S. the participant is marked as a U.S. known participant at block 512. If the participant's address is not in the U.S. the participant is marked as a U.S. unknown participant at block 514.

FIG. 6 is a flow chart illustrating a method for applying Canadian security rules according to one embodiment. At block 602 a shipment is checked for a security code indicating a Canadian security code. If the shipment is not designated with a ‘CA’ security code the participant is marked as having no Canadian security status at block 610. If the shipment is designated with a ‘CA’ security code at block 604 the security ID and security document ID are checked. If the security ID does not equal ‘SECU’ or the security document ID does not equal ‘TC’ or ‘UNKNOWN’ the participant is marked as not having a Canadian security status at block 610. If the security ID equals ‘SECU’ and the security document ID is ‘TC’ or ‘UNKNOWN’ the security document ID is checked at block 606. If the security document ID equals ‘TC’ the participant is marked as having a known Canadian security status at block 612. If the security ID does not equal ‘TC’ the participant is marked as having an unknown Canadian security status.

Although United States and Canadian security checks are described in FIGS. 5, and 6, additional rules for other countries may be added when the security rules for an air waybill are identified. For example, security rules for Mexico or Brazil may be added and assigned security codes. Additionally, security rules may be established by airlines, truckers, or other shipment handlers.

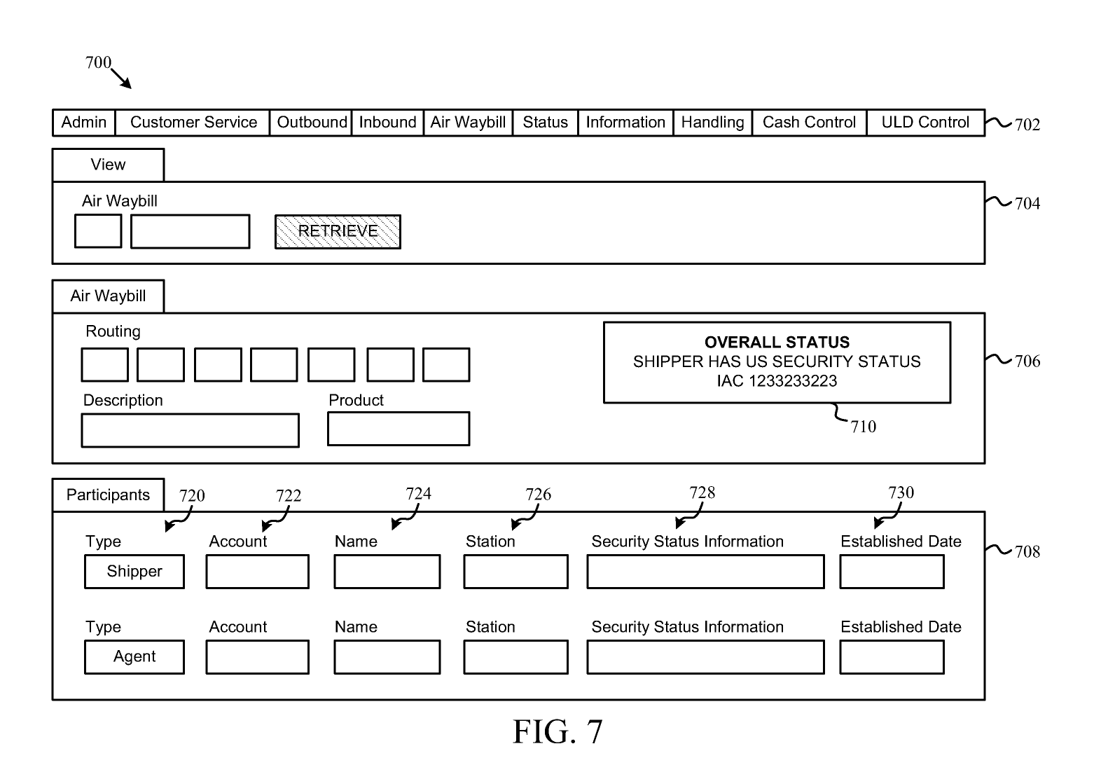

After a security check is performed on a shipment a status message may be displayed to a user on the air waybill for the shipment. FIG. 7 is a form illustrating participant information and status messages according to one embodiment. A form 700 may include a menu control 702 and sections 704, 706, 708. The section 704 may include input boxes and controls allowing a user to view a specific air waybill. The section 706 may include input boxes and controls displaying information about a specific air waybill and/or allowing a user to edit information on the specific air waybill. Additionally, the section 706 may include a status message 710 indicating the outcome of a security check. The section 708 may include input boxes and controls displaying information about participants for the specific air waybill and/or allowing a user to edit the participant information for the specific air waybill. The participant information may include a box 720 for a participant type, a box 722 for a participant's account number, a box 724 for a participant's name, a box 726 for a participant's station, a box 728 for a participant's security status information, and/or a box 730 for a participant's established date. The boxes 720, 722, 724, 726, 728, 730 may be repeated on multiple rows within the section 708 for additional participants on an air waybill. For example, the participants may include a shipper, an IATA agent, and/or a consignee.

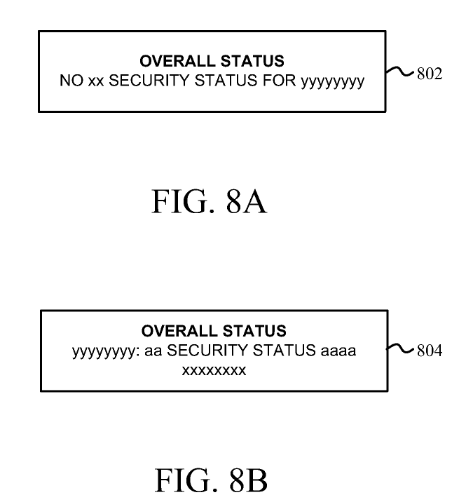

According to one embodiment, the message and color of the status message 710 may be altered to call the attention to security check failures. For example, the status message 710 may have a red color when a participant of the air waybill fails security checks and a blue color when a participant of the air waybill passes security checks. Additionally, colors for the input boxes and controls in the sections 704, 706, 708 may be altered to alert a user of the of the security check failure. Additional messages may be displayed in the status message 710. Referring now to FIGS. 8A-B, block diagrams are shown illustrating status messages for an air waybill according to one embodiment.

FIG. 8A is a block diagram illustrating a status message according to one embodiment. When a participant on an air waybill has no security status a message 802 may be displayed on the air waybill. The message 802 displays “NO xx SECURITY STATUS FOR yyyyyyyy,” where xx represents a security code (e.g., ‘US’ or ‘CA’) and yyyyyyyy represents a participant (e.g., shipper or IATA agent). For example, when a shipper has no security status for an air waybill with a security code of ‘US,’ the message 802 may display “NO US SECURITY STATUS FOR SHIPPER.” According to one embodiment, the message 802 may be displayed in a red color to alert a user to the security check failure.

FIG. 8B is a block diagram illustrating a status message according to one embodiment. When a participant on an air waybill has security status corresponding to the security code of the air waybill a message 804 may be displayed on the air waybill. The message 804 displays “yyyyyyyy: aa SECURITY STATUS aaaa xxxxxxxx,” where yyyyyyyy represents a participant (e.g., shipper or IATA agent), aa represents a security code (e.g., ‘US’ or ‘CA’), aaaa represents a security identifier (e.g., a four-digit number), and xxxxxxxx represents a security document identifier (e.g., an eight-digit number). For example, when a shipper has security status for an air waybill with a security code of ‘US,’ a security identifier of ‘1234,’ and a security document identifier of ‘12345678,’ the message 804 may display “SHIPPER: US SECURITY STATUS 1234 12345678.” According to one embodiment, the message 804 may be displayed in a blue color to alert a user that a participant of the air waybill has passed the security check.

Modifications may be made to the system of FIG. 3 to implement the security checks and display the messages described in FIGS. 4, 5, 6, 7, 8A, and 8B. For example, the processor 302 may be configured with a C$IANS parameter indicating that shipper statuses for ‘Indirect Air Carrier certificate number’ (IAC) and NOSHIP are enabled. When IAC and NOSHIP are enabled a system employing the processor 302 includes the security checks described in FIGS. 4, 5, and 6. According to one embodiment, C$IANS parameter may be ‘0’ indicating the IAC and NOSHIP statuses are disabled or the C$IANS parameter may be ‘1’ indicating the IAC and NOSHIP statuses are enabled for participants listed on an air waybill. A participant with the NOSHIP status may be prevented by the processor 302 from being entered on an air waybill as a shipper.

Additionally, a ‘Security Data’ field may be configured on the processor 302 to indicate if shipper and agent security checks are implemented on user stations having the processor 302. The ‘Security Data’ field may store different values on different user terminals at different locations. For example, a user terminal located in the United States may have the ‘Security Data’ field set to ‘1’ to implement the security rules described in FIG. 5. However, a user terminal located in Costa Rica may have the ‘Security Data’ field set to ‘0’ to disable security checks on the user terminal.

The processor 302 may further be configured with an ‘ES$SECURITY_MESSAGE’ parameter for controlling a method of displaying the generated security message. According to one embodiment, air waybills are displayed on the display 324 with display adapter 322. When the ‘ES$SECURITY_MESSAGE’ parameter is a ‘0’ the generated security message may be displayed on the display 324. For example, the generated security message may be displayed on air waybill information screens, express air waybill information screens, accept goods screens, and/or goods information screens. When the ‘ES$SECURITY_MESSAGE’ parameter is a ‘1’ the generated security message may be displayed on the display 324 and wait for user acknowledgement of the generated security message. For example, the generated security message may be displayed on the display 324 as a pop-up window including text describing the security message and an ‘OK’ button for the user to press before proceeding to other tasks on the display 324.

The description of several parameters refers to logical “0” or “low” and logical “1” or “high” in certain locations, one skilled in the art appreciates that the logical values can be switched, with the processor adjusted accordingly, without affecting operation of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
determining, in a processor, if a shipment is subject to a security check;
applying, in the processor, at least one security rule to information regarding the shipment; and
if at least one security rule fails during application to the information regarding the shipment then generating, in the processor, a security message.

2. The method of claim 1, further comprising displaying, through a display adapter, an air waybill associated with the shipment, in which the air waybill includes the generated security message if at least one security rule fails during application.

3. The method of claim 2, in which the air waybill includes a passing security message comprising at least one of a security identifier and a security document identifier if none of the at least one security rules fails.

4. The method of claim 1, in which the at least one security rule applied to the shipment is selected from a set of security rules stored in a data storage unit.

5. The method of claim 4, in which the at least one security rule applied to the shipment is selected from the set of security rules stored in the data storage unit based, in part, on a security code assigned to the shipment.

6. The method of claim 1, in which the at least one security rule applied to the shipment is selected based, in part, on a country associated with the shipment.

7. The method of claim 1, in which the information regarding the shipment comprises at least one of a participant type, a participant account, a participant name, a participant station, a participant security status, and a participant established date.

8. The method of claim 1, further comprising:
determining, in the processor, if an exception applies to the shipment; and
if an exception applies then not generating the security message.

9. A computer program product, comprising:
a computer-readable medium comprising:
code to determine if a shipment is subject to a security check;
code to apply at least one security rule to information regarding the shipment; and
code to generate a security message if at least one security rule fails during application to the information regarding the shipment.

10. The computer program product of claim 9, in which the medium further comprises code to display an air waybill associated with the shipment, in which the air waybill includes the generated security message if at least one security rule fails.

11. The computer program product of claim 10, in which the code to display the air waybill displays a passing security message comprising at least one of a security identifier and a security document identifier if none of the security rules fails.

12. The computer program product of claim 10, in which the medium further comprises code to select the at least one security rule from a set of security rules.

13. The computer program product of claim 12, in which the code to select selects the at least one security rule based, in part, on a security code assigned to the shipment.

14. The computer program product of claim 9, in which the code to apply at least one security rule applies a security rule based, in part, on a country associated with the shipment.

15. An apparatus, comprising:
at least one processor; and
a memory coupled to the at least one processor,
in which the at least one processor is configured:
to determine if a shipment is subject to a security check;
to apply at least one security rule to information regarding the shipment; and
to generate a security message if at least one security rule fails during application to the information regarding the shipment.

16. The apparatus of claim 15, in which the at least one processor is further configured to display an air waybill associated with the shipment, in which the air waybill includes the generated security message if at least one security rule fails.

17. The apparatus of claim 16, in which the at least one processor is further configured to display a passing security message comprising at least one of a security identifier and a security document identifier if none of the security rules fails during application.

18. The apparatus of claim 16, in which the at least one processor is further configured to select the at least one security rule from a set of security rules.

19. The apparatus of claim 18, in which the at least one processor is further configured to select the at least one security rule according to a security code assigned to the shipment.

20. The apparatus of claim 15, in which the at least one processor is further configured to apply the at least one security rule based, in part, on a country associated with the shipment.
